(19) United States
(12) Patent Application Publication
(10) Pub. No.: US 2020/0334589 A1
(43) Pub. Date: Oct. 22, 2020

(54) RESERVATION MANAGEMENT SYSTEM AND NON-TRANSITORY COMPUTER READABLE MEDIUM STORING PROGRAM

(71) Applicant: FUJI XEROX CO., LTD., Tokyo (JP)

(72) Inventor: Kana MIYAZAKI, Kanagawa (JP)

(73) Assignee: FUJI XEROX CO., LTD., Tokyo (JP)

(21) Appl. No.: 16/825,499

(22) Filed: Mar. 20, 2020

(30) Foreign Application Priority Data
Apr. 16, 2019 (JP) 2019-077914

(51) Int. Cl. G06Q 10/02; G06Q 10/10

(52) U.S. Cl. CPC G06Q 10/025; G06Q 10/1093

(57) ABSTRACT

A reservation management system includes a processor programmed to: acquire information used to determine whether a user will arrive in time for a first event, a user reservation, through movement between a first event location and a second event location of the user, which precedes the first event, or information used to determine whether the user will arrive in time for a third event, which succeeds the first event, through movement between the location of the first event and a location related to the third event; make a determination whether the user will arrive in time for the first event or the third event; and in response to a result of the determination being that the user will arrive late to the first event or the third event, provide a notification that prompts the user to take an action on the first event or the third event.

### CROSS-REFERENCE TO RELATED APPLICATIONS

This application is based on and claims priority under 35 USC 119 from Japanese Patent Application No. 2019-077914 filed Apr. 16, 2019.

### BACKGROUND

### (i) Technical Field

The present disclosure relates to a reservation management system and a non-transitory computer readable medium storing a program.

### (ii) Related Art

Nowadays, there is a service in which reservations may be made for use of spaces on a time basis. The spaces are typified by an open space and a box space surrounded by walls. Examples of currently available services include a service in which reservations may be made on a time basis for use of box spaces in stations or passages. This service provides effective use of idle time from one place to another.

Japanese Unexamined Patent Application Publication No. 2017-167636 is an example of related art.

### SUMMARY

Aspects of non-limiting embodiments of the present disclosure relate to the following circumstances. The time when a reservation is made for use of a space is not limited to a time immediately before an expected time of use of the space. For example, a reservation may be made before an expected date of use of a space.

The use of a space secured by making a reservation is an event in a daily life or activity of a user. A new event may later be created before or after an expected time of use of the space or an event preceding the use of the space may be finished late accidentally.

Users have responsibility of judging whether they may arrive in time between two successive events. The users may misjudge whether they may arrive in time at a space secured by a reservation.

It is desirable that the users may judge in advance whether to take any action on a reservation for a space unlike a case where the users are not notified even if they may arrive late at a place secured by the reservation or at a place of a succeeding event.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a reservation management system comprising a processor programmed to: acquire information used to determine whether a user will arrive in time for a first event, which is a reservation for the user, through movement between a location of the first event and a location related to a second event of the user, which precedes the first event, or information used to determine whether the user will arrive in time for a third event, which succeeds the first event, through movement between the location of the first event and a location related to the third event; make a determination whether the user will arrive in time for the first event or the third event; and in response to a result of the determination being that the user will arrive late to the first event or the third event, provide a notification that prompts the user to take an action on the first event or the third event.

### BRIEF DESCRIPTION OF THE DRAWINGS

An exemplary embodiment of the present disclosure will be described in detail based on the following figures, wherein:

FIG. 1 schematically illustrates an example of the overall configuration of a management system for use in an exemplary embodiment;

FIG. 2 illustrates an example of a booth type space;

FIG. 3 illustrates an example of the hardware configuration of each management server for use in the exemplary embodiment;

FIG. 4 illustrates an example of the hardware configuration of a user terminal for use in the exemplary embodiment;

FIG. 5 illustrates an example of management data managed by a space reservation server;

FIG. 6 illustrates an example of management data managed by a schedule management server;

FIG. 7 illustrates an example of the functional configuration of a movement management server;

FIG. 8 illustrates an example of the functional configuration of a movement determination module of the exemplary embodiment;

FIG. 9 is a flowchart for describing an example of processing to be executed by the movement management server;

FIG. 10 illustrates an example of a notification screen to be displayed on the user terminal;

FIG. 11 illustrates another example of the notification screen to be displayed on the user terminal; and

FIG. 12 illustrates another example of the notification screen to be displayed on the user terminal.

### DETAILED DESCRIPTION

An exemplary embodiment of the present disclosure is described below with reference to the drawings.

### Exemplary Embodiment

Nowadays, many business persons work in spaces other than their offices because of downsizing of communication devices and an increase in communication speed. For example, business persons attend meetings or visit customers in spaces other than their offices. Further, business persons may work in spaces secured by reservations for the purpose of effective use of idle time from one place to another.

Nowadays, schedules may be managed as electronic data. For example, schedules may be managed by using an application program installed in a smartphone or by using a network service or a cloud service. Examples of schedule management include management of a schedule of a person and management of schedules of a plurality of persons. A service intended to share schedules of a plurality of persons is called “groupware”.

In this exemplary embodiment, each event in a schedule is managed based on a start time and an end time. Each event includes information for identifying a space to be used by a business person. The space for use in an event may be a space that requires a reservation or a space that does not require a reservation.

The space that requires a reservation is managed by a business entity that provides the space. A terminal that manages reservations for the space does not basically grasp other events of a person who has made a reservation. Therefore, the person basically has responsibility of judging whether he/she may arrive in time from a space of one event to a space of another succeeding event. As a result, the person may arrive late at the space secured by the reservation.

In this exemplary embodiment, description is made of a service in which a user who makes a reservation is notified whether he/she may arrive in time for an event created by the reservation or an event in a user's schedule through movement between a space that does not require a reservation and a space that requires a reservation.

### <Overall Configuration of Space Reservation System>

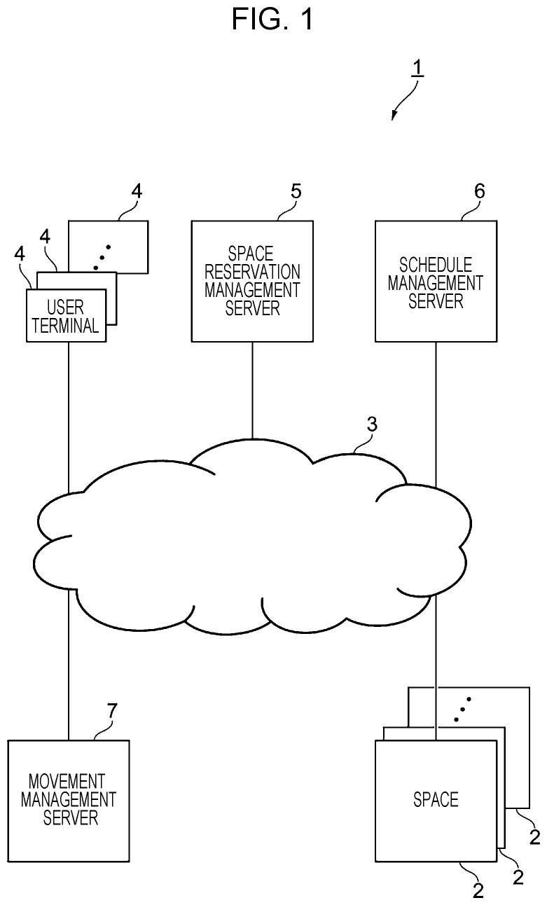

FIG. 1 schematically illustrates an example of the overall configuration of a management system 1 for use in the exemplary embodiment.

The management system 1 of this exemplary embodiment provides a notification service for movement of persons who make reservations for spaces 2.

In this exemplary embodiment, the spaces 2 include a booth, a room of an accommodation or the like, and a meeting room of a company or the like. Those spaces are examples of a space demarcated from surroundings with walls, partitions, or the like. The spaces 2 of this exemplary embodiment include a table and a seat in a restaurant or a barbershop where a service is provided. Those spaces are examples of a space open to surroundings.

Each space 2 of this exemplary embodiment has address information or other locational information necessary in a search for routes from other places or routes to other places.

The space 2 of this exemplary embodiment is assigned a name, a number, or the like for management.

Reservations of the space 2 may be chargeable or free of charge.

The management system 1 illustrated in FIG. 1 includes various terminals connected to a cloud network 3.

FIG. 1 illustrates the spaces 2, user terminals 4, a space reservation management server 5, a schedule management server 6, and a movement management server 7 as examples of the terminals connected to the cloud network 3. Users make reservations for the spaces 2. Users operate the user terminals 4. The space reservation management server 5 manages reservations for the spaces 2. The schedule management server 6 manages schedules of users who make reservations. The movement management server 7 manages possibilities of whether users may arrive in time for a succeeding event between a plurality of successive events.

The space 2 does not necessarily have functions of a terminal as in a case where the space 2 is a table or a seat where a service is provided for a person who makes a reservation.

In the case of FIG. 1, one server is prepared for each purpose or function. That is, one space reservation management server 5, one schedule management server 6, and one movement management server 7 are prepared.

A plurality of servers may be prepared for one purpose or function or one server may be shared for a plurality of purposes or functions.

The number of business entities that manage reservations for a certain space 2 may be one or plural. For example, different business entities may individually have responsibilities for management of reservations, management of entry/exit and usages of rooms, management of charges for use on users, and management of members registered as users.

As described above, the spaces 2 to be managed for reservations need not be the same type of space. For example, a subset of the spaces 2 may be booths and another subset of the spaces 2 may be a seat and a table in a restaurant or the like.

A plurality of business entities may offer management of one purpose or function in cooperation.

If an electronic lock is attached to a door of the space 2, the space 2 is available under a condition that the user has an electronic key provided in advance. If the space 2 has no door, the space 2 is available, for example, under a condition that a person who has made a reservation is authenticated by using an authentication code provided in advance or a manager of the space 2 verifies the name of the person.

In this exemplary embodiment, the user terminal 4 is assumed to be a smartphone to be carried by a user who makes a reservation. The portable user terminal 4 may be a so-called wearable terminal, a notebook computer, or a game console.

The space reservation management server 5 manages various types of information related to reservations for the spaces 2. For example, the space reservation management server 5 manages information for identifying persons who make reservations, information for identifying the spaces 2 to be secured by reservations, start times of reservations, and end times of reservations.

Examples of the information for identifying a person who makes a reservation include a name, sex, and age of the person, an account, a password, and individual management information. Examples of the information for identifying a space 2 to be secured by a reservation include information for identifying an address or a location, a management name, and a management number.

The space reservation management server 5 may manage reservations for goods and services associated with the space 2. For example, the space reservation management server 5 may manage items for rent, and goods and services sold and/or consumed at the space 2.

In this exemplary embodiment, the reservation information managed by the space reservation management server 5 is accessible to the movement management server 7 under agreement of a user who makes a reservation.

The schedule management server 6 is a terminal in which an application or groupware is executed for management of a schedule by a user who makes a reservation. If the user's schedule is managed by using an application installed in the user terminal 4, the schedule management server 6 is unnecessary. For example, the schedule management server 6 manages an account and a password of the user for management, the subject of the schedule, a place of a scheduled event, a start time, and an end time.

In this exemplary embodiment, the reservation information managed by the schedule management server 6 is accessible to the movement management server 7 under agreement of a user of the space 2.

The movement management server 7 is a terminal that provides a service for managing a possibility of whether a user may arrive in time from a place of a preceding event to a place of a succeeding event within a period from an end time of the preceding event to a start time of the succeeding event.

The events include events created by reservations. The movement management server 7 manages possibilities of whether a user may arrive in time from a space 2 of an event created by a reservation to a space 2 of another event, from a place set for an event to a space 2 of another event created by a reservation, and from a space 2 of an event created by a reservation to a place set for another event.

For example, the movement management server 7 of this exemplary embodiment acquires information on a reservation and a schedule set by each user from the space reservation management server 5 and the schedule management server 6 by using a user account.

The movement management server 7 of this exemplary embodiment determines whether a user may arrive in time between each event created by a reservation and another event before or after the event created by the reservation. If the user may arrive late, the user is notified in advance. The functions of the movement management server 7 may be implemented by an application installed in the user terminal 4.

The movement management server 7 is an example of a reservation management system.

### <External Structure of Space>

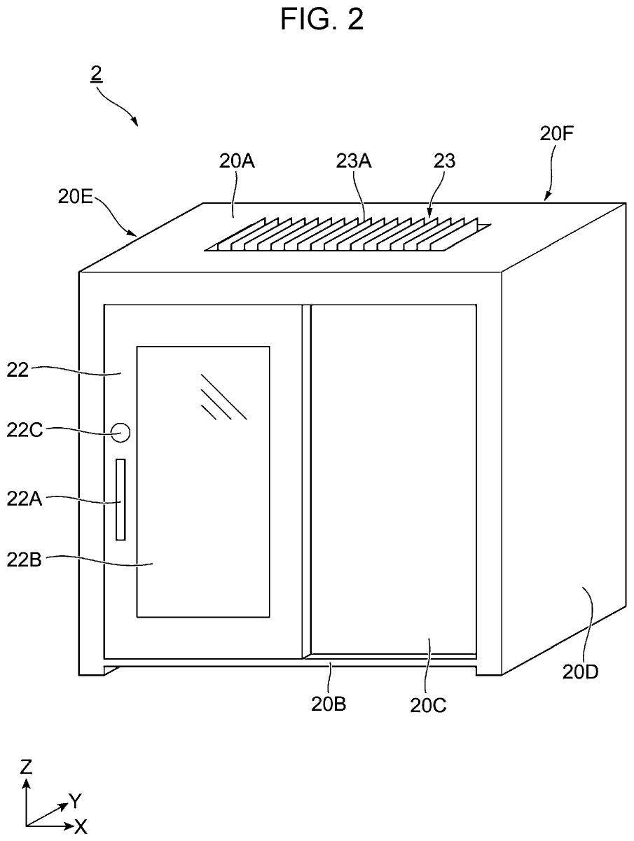

FIG. 2 illustrates an example of a booth type space 2. The booth type space 2 illustrated in FIG. 2 is arranged irrespective of indoors or outdoors. For example, the booth type space 2 is arranged in a station yard, an airport, an office building, a commercial facility such as a restaurant or a department store, a bank, a library, an art gallery, a museum, a public institution or facility, an accessway, or a park.

The booth type space 2 illustrated in FIG. 2 is a closed booth having a ceiling. The term “closed” does not mean “sealed” and the closed booth only needs to have a practical sound-proof property. Therefore, an opening or clearance such as an air vent or a small window may be provided in a portion of a frame that defines the space 2. The window may be openable and closable.

The frame of the space 2 illustrated in FIG. 2 includes a ceiling 20A, a floor 20B, a wall 20C having an openable and closable door 22, two walls 20D and 20E located on both sides of the wall 20C, and a wall 20F located opposite the door 22.

In the case of FIG. 2, the ceiling 20A has a ventilating hole 23. A louver 23A capable of adjusting the opening area is attached to the ventilating hole 23. The louver 23A of FIG. 2 is fully open.

In this exemplary embodiment, the door 22 is assumed to be a sliding door movable along the wall 20C. In the case of FIG. 2, the door 22 is a single sliding door that slides in one direction. The door 22 may be a double sliding door to be opened or closed by moving two or more members in different directions, or a drawn door having two members slidable to right and left.

The door 22 is not limited to the sliding door. For example, the door 22 may be a single hinged door having one swingable member, or a double hinged door having one opening closed by two door members.

The door 22 may be a folding door to be opened by folding a pair of door members coupled by hinges. The folding door may be a folding door of a type in which door members are opened in one direction, or in which door members are opened in two directions.

As a special type of door, the door 22 may be a partition door or a retractable sliding door to be retracted into a wall when the door 22 is opened.

The door 22 may be opened inward or outward.

In this exemplary embodiment, the door 22 has a handle 22A to be gripped by a user when the door 22 is opened or closed.

A member 22B subjected to treatment in consideration of confidentiality and security is arranged at the center of the door 22. For example, the member 22B may be a transparent plate in which a metal plate having many arrays of holes (for example, a perforated metal) is attached on an inner side, a transparent plate in which a screen member is attached on an inner side with a clearance, a transparent plate having a film that makes it easy to view the inside from the front but difficult to view the inside in a slanting direction, or a transparent plate subjected to treatment for reducing internal visibility.

For example, glass or an acrylic resin is used for the transparent plate. A characteristic related to the transparency of the film bonded for confidentiality and security is determined based on a relationship between the position of the door 22 and the working position of the user. If the user works on a far side behind the front of the door 22, it is appropriate to use a film that makes it difficult to view the inside from the front but easy to view the inside in a slanting direction.

The film may be a liquid crystal film whose transparent state and opaque state are switchable electrically, or a polarizing film whose transmittance is controllable electrically.

Examples of the treatment for reducing visibility include finely scoring the surface of the member so that light is scattered.

The treatment may be performed on a portion of the member 22B. For example, the structure may be provided such that the member 22B is transparent near the floor and the ceiling and the visibility is reduced through the treatment in a range in which a monitor may be viewed during work.

By arranging the member 22B, the presence or absence of the user may be confirmed from the outside while hiding a screen of the monitor from the outside.

An electronic lock 22C unlockable with an electronic key is attached to the door 22.

The treatment in consideration of confidentiality and security may be performed on a member other than the door 22. For example, the treatment in consideration of confidentiality and security may be performed on at least a portion of the wall 20D, 20E, or 20F.

The number of users of the space 2 is roughly determined depending on the volume of the space 2. The space 2 of this exemplary embodiment is assumed to be a private room that is basically used alone. The space 2 may be a large room capable of accommodating many people. The large room may be formed as a single room but may be formed by removing one or both of the walls 20D and 20E of the space 2 and coupling a plurality of spaces 2.

The private room does not mean that the room may be used alone but means that the room may be used by a few people such as two or three people.

The shape and structure of the frame that defines the space 2 and the provided equipment and performance thereof are arbitrary. For example, the ceiling 20A may be omitted.

In this exemplary embodiment, one desk and one chair (not illustrated) are arranged in the frame. Furnished equipment and devices or reserved equipment and devices are arranged on the desk.

### <Configurations of Terminals>

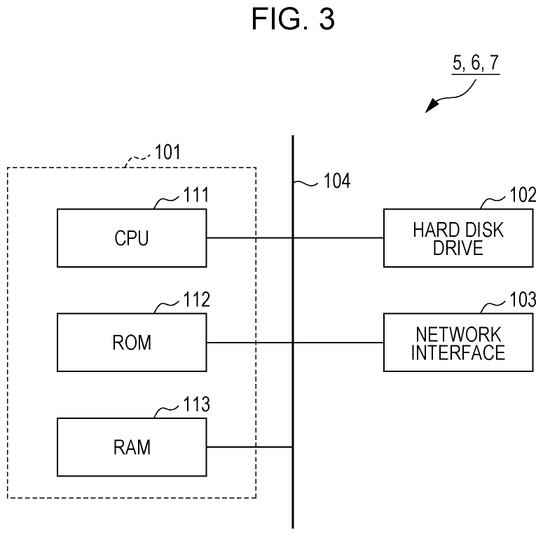

FIG. 3 illustrates an example of the hardware configuration of each management server for use in the exemplary embodiment. The management servers of this exemplary embodiment are the space reservation management server 5 (see FIG. 1), the schedule management server 6 (see FIG. 1), and the movement management server 7 (see FIG. 1).

The management server includes a control unit 101 that controls an overall operation of the apparatus, a hard disk drive 102 that stores management data and the like, and a network interface 103 that achieves communication via a local area network (LAN) cable or the like.

The control unit 101 includes a central processing unit (CPU) 111, a read only memory (ROM) 112 that stores basic software, a basic input/output system (BIOS), and the like, and a random access memory (RAM) 113 to be used as a working area. The CPU 111 may be a multi-core CPU. The ROM 112 may be a rewritable non-volatile semiconductor memory. The control unit 101 is a so-called computer.

The hard disk drive 102 is an apparatus that reads and writes data on a non-volatile storage medium obtained by applying a magnetic substance to the surface of a disc-shaped substrate. The non-volatile storage medium may be a semiconductor memory or a magnetic tape.

As necessary, the management server includes an input device such as a keyboard and a mouse, and a display device such as a liquid crystal display.

The control unit 101, the hard disk drive 102, and the network interface 103 are connected through a bus 104 and signal lines (not illustrated).

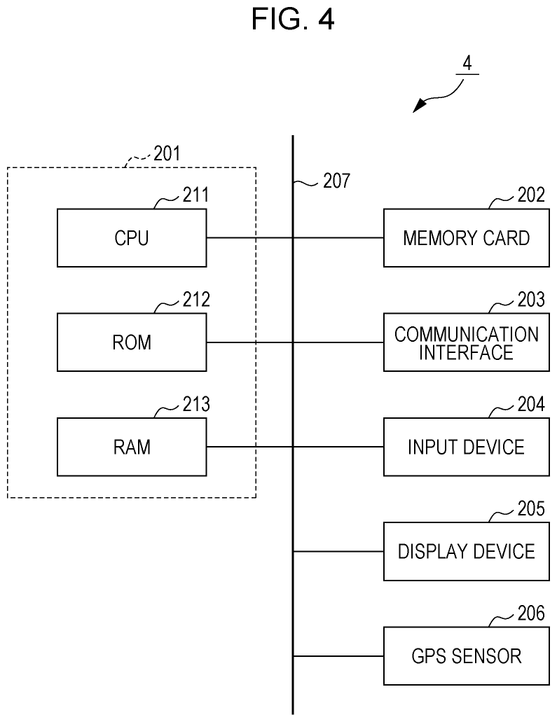

FIG. 4 illustrates an example of the hardware configuration of the user terminal 4 for use in the exemplary embodiment. The configuration illustrated in FIG. 4 is assumed to be a configuration when the user terminal 4 is a smartphone.

The user terminal 4 includes a control unit 201 that controls an overall operation of the apparatus, a memory card 202 that stores various types of data, various types of communication interface 203 conforming to wireless communication standards, an input device 204 such as a touch sensor, a display device 205 such as a liquid crystal display or an organic electroluminescence (EL) display, and a Global Positioning System (GPS) sensor 206.

The control unit 201 includes a CPU 211, a ROM 212 that stores firmware, a BIOS, and the like, and a RAM 213 to be used as a working area. The CPU 211 may be a multi-core CPU. The ROM 212 may be a rewritable non-volatile semiconductor memory.

For example, the communication interface 203 is an interface to be used for connection to a mobile communication system, or an interface to be used for connection to a wireless LAN.

The GPS sensor 206 measures the position of the user terminal 4 by receiving an electric wave from a GPS satellite. Information on a latitude, a longitude, and an altitude output from the GPS sensor 206 provides a current position of the user terminal 4. The GPS sensor 206 may be compatible with an indoor positioning system.

### <Example of Management Data>

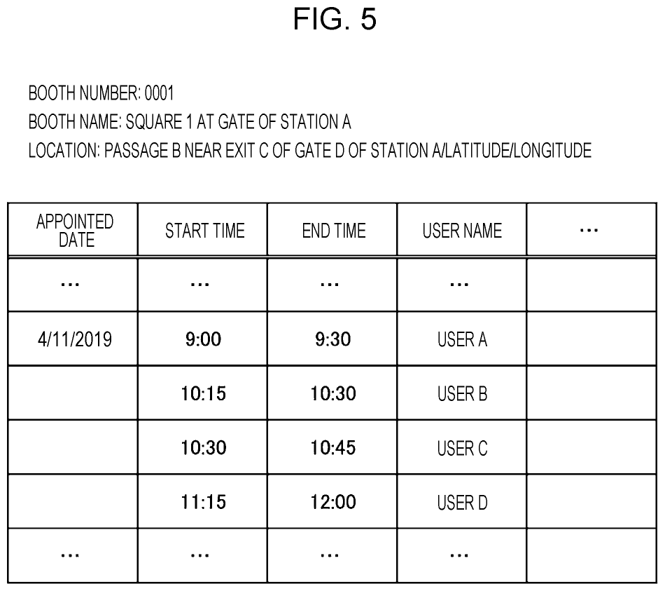

FIG. 5 illustrates an example of management data managed by the space reservation management server 5 (see FIG. 1).

The space reservation management server 5 of this exemplary embodiment manages reservation information for each space 2 to be secured by reservations.

The management data illustrated in FIG. 5 is an example of management data on a space 2 having a booth number “0001” and a booth name “Square 1 at gate of Station A”. In this space 2, locational information for management of persons and locational data on a latitude and a longitude are recorded as information for identifying the location.

In the case of FIG. 5, the reservation management data includes an appointed date, a start time, an end time, a user name, and the like. For example, a “user A” has made a reservation for a time frame of “9:00” to “9:30” on “4/11/2019”.

In the case of FIG. 5, reservations may be made for a time frame in the units of 15 minutes. Other units may be employed, such as 10 minutes.

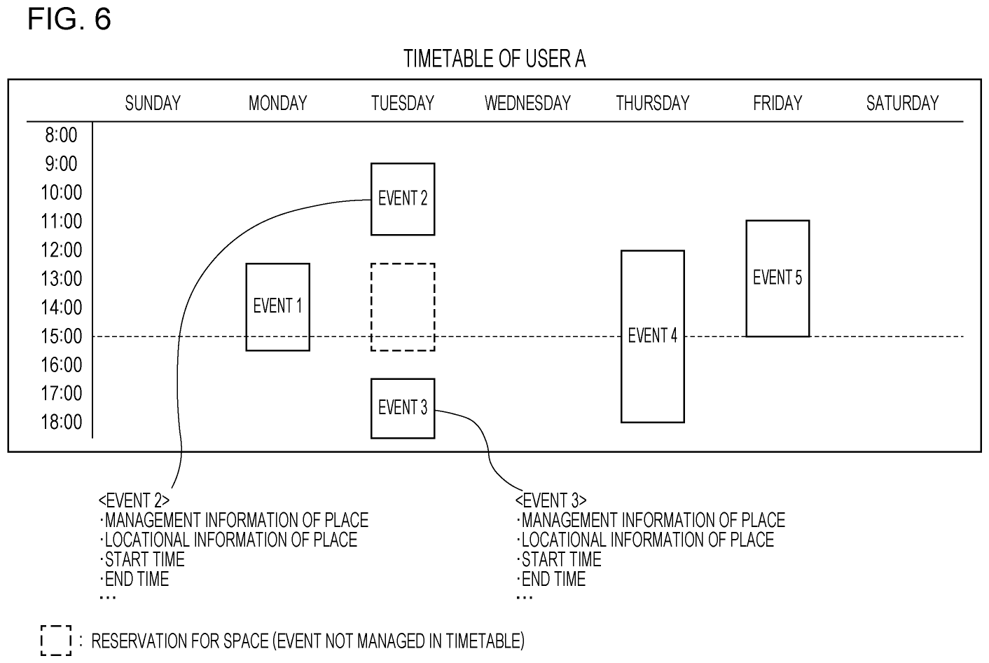

FIG. 6 illustrates an example of management data managed by the schedule management server 6 (see FIG. 1).

In FIG. 6, the management data is shown in a timetable. Schedules are managed for each user. The timetable illustrated in FIG. 6 shows a schedule on a certain week of the user A.

In the case of FIG. 6, “Event 1” is set in a time frame of 12:30 to 15:30 on Monday. “Event 2” is set in a time frame of 9:00 to 11:30 and “Event 3” is set in a time frame of 16:30 to 18:30 on Tuesday. “Event 4” is set in a time frame of 12:00 to 18:00 on Thursday. “Event 5” is set in a time frame of 11:00 to 15:00 on Friday.

In the case of FIG. 6, each event is managed based on management information of a place such as a name, locational information of the place, a start time, and an end time.

In FIG. 6, a time frame of an event that is not managed in the timetable is enclosed by a broken line box. For example, this event is created by a reservation managed by the space reservation management server 5.

### <Functional Configuration of Movement Management Server>

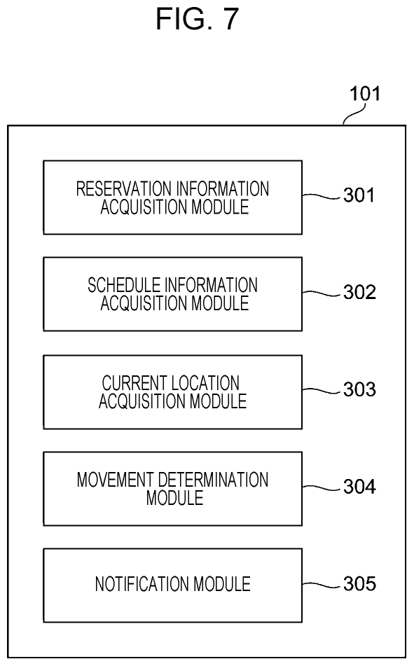

FIG. 7 illustrates an example of the functional configuration of the movement management server 7 (see FIG. 1).

The functions of the movement management server 7 are implemented by executing programs by the control unit 101. The programs corresponding to the respective functions are hereinafter referred to as “modules”.

The movement management server 7 according to this exemplary embodiment functions as a reservation information acquisition module 301, a schedule information acquisition module 302, a current location acquisition module 303, a movement determination module 304, and a notification module 305. The reservation information acquisition module 301 acquires reservation information from the space reservation management server 5 (see FIG. 1). The schedule information acquisition module 302 acquires schedule information from the schedule management server 6 (see FIG. 1). The current location acquisition module 303 acquires a current location of a user. The movement determination module 304 determines whether the user may arrive late between an event created by a reservation subjected to determination and another event before or after the event created by the reservation. If the user may arrive late for the succeeding event, the notification module 305 transmits a notification that prompts the user to change the event.

The reservation information acquisition module 301 acquires reservation information on a space 2 (see FIG. 1) for a user of the notification service. The reservation information acquisition module 301 is an example of an acquirer.

The schedule information acquisition module 302 acquires timetable information on the user of the notification service. The schedule information acquisition module 302 is an example of the acquirer.

The current location acquisition module 303 acquires, from a user terminal 4 (see FIG. 1), locational information measured by the GPS sensor 206 (see FIG. 4). The acquired locational information is a current location of the user. For example, the current location of the user is used for determining whether the user may arrive in time if the user has left a place of a preceding event. The current location acquisition module 303 is an example of the acquirer.

The movement determination module 304 determines whether the user may arrive in time for a succeeding event based on information on a moving period between an event created by a reservation subjected to determination and another event set in a time frame before or after the event created by the reservation, a movement method, and a route determined depending on the movement method. The other event includes an event created by a different reservation.

If determination is made that the user may arrive late, the notification module 305 transmits a notification that prompts the user to change related events. If determination is made that the user may arrive in time, the notification module 305 does not transmit a notification. The notification module 305 is an example of a notifier.

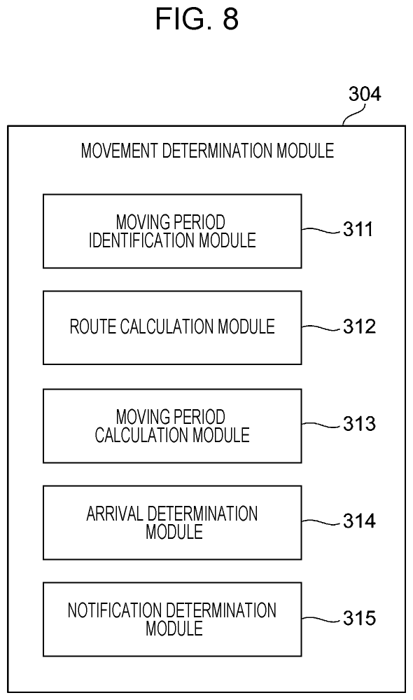

FIG. 8 illustrates an example of the functional configuration of the movement determination module 304 (see FIG. 7) of this exemplary embodiment.

The movement determination module 304 according to this exemplary embodiment functions as a moving period identification module 311, a route calculation module 312, a moving period calculation module 313, an arrival determination module 314, and a notification determination module 315. The moving period identification module 311 identifies a period allocable to movement between two events without any other event therebetween. The route calculation module 312 calculates a route from a place of a preceding event to a place of a succeeding event. The moving period calculation module 313 calculates a period required for movement in each route. The arrival determination module 314 determines whether a user may arrive late in each route. The notification determination module 315 determines whether to transmit a notification based on a determination result.

In this exemplary embodiment, the period allocable to movement between two events is identified as, for example, a period between an end time of a preceding event and a start time of a succeeding event.

The user does not always start to move at the end time of an event or may arrive earlier than the start time of an event for preparation.

Therefore, the period allocable to movement may be identified in consideration of a predetermined adjustment period. An adjustment period corresponding to a period from the end time of an event to the start of movement may be set independently of an adjustment period corresponding to a period from arrival at a place of a succeeding event to the start time of the event. The adjustment period may be set by each user.

The period allocable to movement may be adjusted depending on the number of users involved in a preceding event serving as a start point of movement. For example, if the preceding event is a meeting that a plurality of persons participate in, the meeting may still continue at an expected end time.

In this exemplary embodiment, if a plurality of persons are involved in a preceding event serving as a start point of movement, the adjustment period to be added to the end time of the event is set longer than in a case where one person is involved in an event. In other words, the period allocable to movement is set shorter than in the case where one person is involved in an event. For example, the adjustment period is 5 minutes in the case where one person is involved in an event, whereas the adjustment period is 20 minutes in the case where a plurality of persons are involved in an event. The values are examples.

The route calculation module 312 may calculate one or more routes depending on places of two events. For example, if the events take place in the same building, the user may walk between the events. Therefore, one route is basically recommended. In some cases, a plurality of routes may be recommended.

If a moving distance is long, the user may move by car, by bicycle, or by public transport. In urban areas, the user may use a plurality of lines in public transport. In this case, a plurality of routes are calculated.

If the route is calculated, the moving period calculation module 313 calculates a moving period based on a time range of movement. In a case of a route that involves movement by car or by public transport, the period required for movement may vary depending on a time range of movement, a traffic condition, or congestion of railways.

The route calculation module 312 and the moving period calculation module 313 may use services provided by other business entities on the Internet.

The period required for movement is calculated for each route. Therefore, the movement determination module 304 (see FIG. 7) of this exemplary embodiment determines whether the user may arrive in time for a succeeding event in each route. If the adjustment period is set as described above, the movement determination module 304 determines whether the user may arrive in time based on the adjusted period.

In this exemplary embodiment, the movement determination module 304 makes determination, for example, when a new event is created by a reservation or a new event is set in a schedule, or when an existing event created by a reservation or an existing event in a schedule is changed in terms of place or time. The movement determination module 304 makes determination by using latest information available.

### <Processing by Movement Management Server>

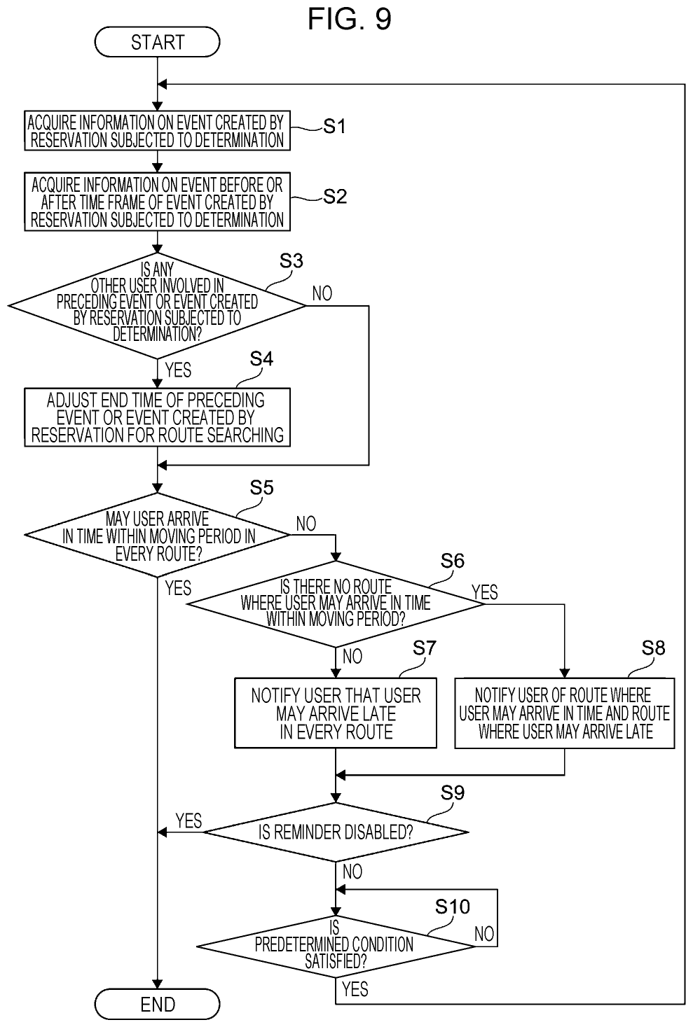

FIG. 9 is a flowchart for describing an example of processing to be executed by the movement management server (see FIG. 1).

The processing illustrated in FIG. 9 is executed for each event created by a user's reservation for which the notification service is provided. For example, the event created by a reservation subjected to determination is an event newly set by a reservation. The event created by a reservation subjected to determination may include an existing event created by a reservation which may be changed due to an event newly set by a reservation or an event newly set in a schedule. The event created by a reservation subjected to determination may also include an existing event created by a reservation which may be influenced by another existing event created by a reservation or an existing event in a schedule whose start time, end time, or place is changed.

First, the movement management server 7 acquires information on an event created by a reservation subjected to determination (Step 1). For example, the movement management server 7 acquires a location of a space 2 (see FIG. 1) for the event created by the reservation, a start time and an end time of the event created by the reservation, and the number of users of the space 2 set by the reservation.

Next, the movement management server 7 acquires, for the same user, information on another event before or after a time frame of the event created by the reservation subjected to determination (Step 2). For example, the movement management server 7 acquires a location set for the acquired event, a start time and an end time of the event, and information on whether the event is shared by other users.

Next, the movement management server 7 determines whether any other user is involved in a preceding event or the event created by the reservation subjected to determination (Step 3).

If the result is “YES” in Step 3, the movement management server 7 adjusts an end time of the preceding event or an end time of the event created by the reservation for route searching (Step 4).

For example, if another user is involved in the event preceding the event created by the reservation subjected to determination, the movement management server 7 delays the end time for route searching. As described above, the reason is because the end time of an event that a plurality of persons are involved in is likely to become later than the end time of an event that one person is involved in if no succeeding event is going to start at the end time of the event. Therefore, the end time for route searching is adjusted by a preset adjustment period. This event includes another event created by a reservation.

The same applies to a case where another user is involved in the event created by the reservation subjected to determination.

If the result is “NO” in Step 3 or after the processing of Step 4 is performed, the movement management server 7 determines whether the user may arrive in time within a moving period in every route (Step 5).

The route is a route from a place of the preceding event to a place of the event created by the reservation subjected to determination, or a route from the place of the event created by the reservation subjected to determination to a place of a succeeding event.

If the determination of Step 5 is made before an expected date of the event created by the reservation subjected to determination or before an expected time of the preceding event on the date of the event created by the reservation, the movement management server 7 determines whether the user may arrive in time in every route without using a location measured by the GPS sensor of the user terminal 4 (see FIG. 1).

If the determination of Step 5 is made after the start of the event created by the reservation subjected to determination or after the start of the event preceding the event created by the reservation subjected to determination, the movement management server 7 determines whether the user may arrive in time by using a location measured by the GPS sensor of the user terminal 4. At this time, the movement management server 7 determines whether the user may arrive in time by acquiring latest traffic information. Thus, the determination may be made more accurately.

If the result is “YES” in Step 5, the movement management server 7 terminates the processing without transmitting a notification.

If the result is “NO” in Step 5, the movement management server 7 determines whether there is no route where the user may arrive in time within the moving period (Step 6).

If the result is “NO” in Step 6, the user may arrive late for the succeeding event or the event created by the reservation in every retrieved route. If the result is “YES” in Step 6, the user may arrive in time for the succeeding event or the event created by the reservation in at least one route.

If the result is “NO” in Step 6, the movement management server 7 notifies the user that the user may arrive late in every route (Step 7).

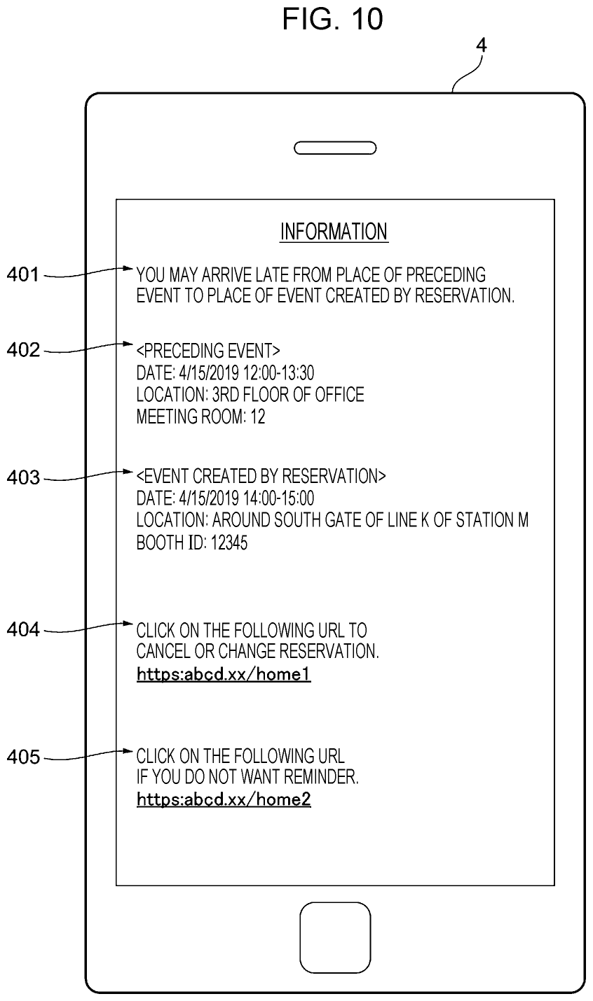

FIG. 10 illustrates an example of a notification screen to be displayed on the user terminal 4 (see FIG. 1). In the example illustrated in FIG. 10, the user is notified if the user may arrive late at the place of the event created by the reservation subjected to determination.

The screen illustrated in FIG. 10 includes a sentence 401 indicating that the user may arrive late at the place of the succeeding event created by the reservation, details 402 of the preceding event, and details 403 of the event created by the reservation.

In the case of FIG. 10, the maximum period allocable to movement from the place of the preceding event to the place of the event created by the reservation is 30 minutes.

The screen illustrated in FIG. 10 further includes information 404 on a link to a dedicated page prepared by the space reservation management server 5 for cancellation or changing of the reservation. By clicking on the link information 404, the user may skip an input operation on a login screen. Examples of the link information 404 include a uniform resource locator (URL). The link information 404 is an example of an address.

The screen illustrated in FIG. 10 further includes link information 405 for disabling, with one click, a reminder to be transmitted if a predetermined condition is satisfied. Examples of the predetermined condition include an elapse of a predetermined period from the last notification, and a timing earlier by a predetermined period than the start time of the event created by the reservation.

The link information 405 is also an example of the address.

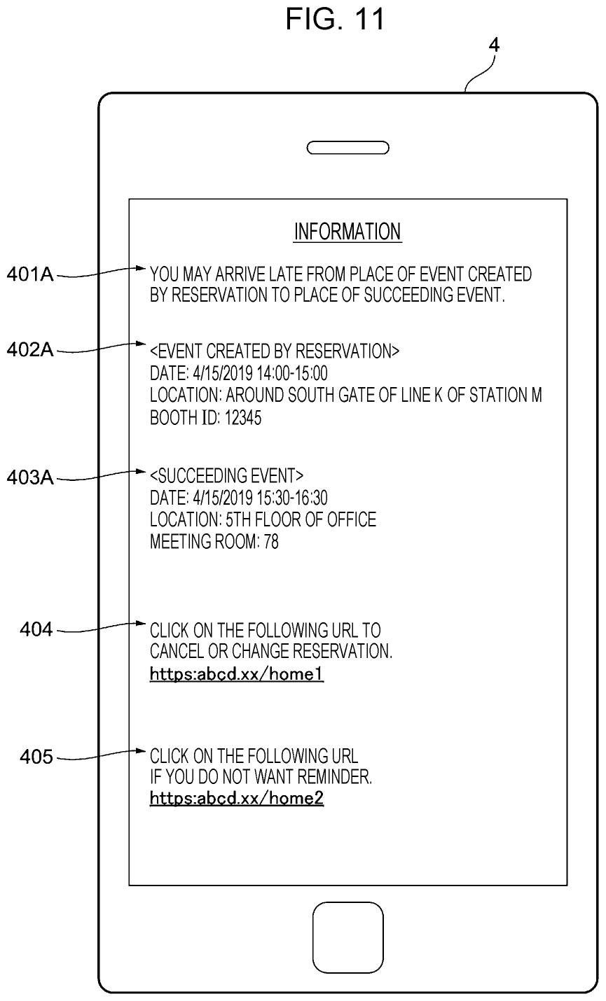

FIG. 11 illustrates another example of the notification screen to be displayed on the user terminal 4 (see FIG. 1). In the example illustrated in FIG. 11, the user is notified if the user may arrive late from the place of the event created by the reservation subjected to determination to the place of the succeeding event.

FIG. 11 shows reference symbols corresponding to those in FIG. 10.

The screen illustrated in FIG. 11 includes a sentence 401A indicating that the user may arrive late at the place of the succeeding event, details 402A of the event created by the reservation, and details 403A of the succeeding event.

In the case of FIG. 11, the maximum period allocable to movement from the place of the event created by the reservation to the place of the succeeding event is 30 minutes.

The screen illustrated in FIG. 11 also includes the link information 404 and the link information 405.

Description returns to the processing in FIG. 9.

If the result is “YES” in Step 6, the movement management server 7 notifies the user of a route where the user may arrive in time and a route where the user may arrive late (Step 8).

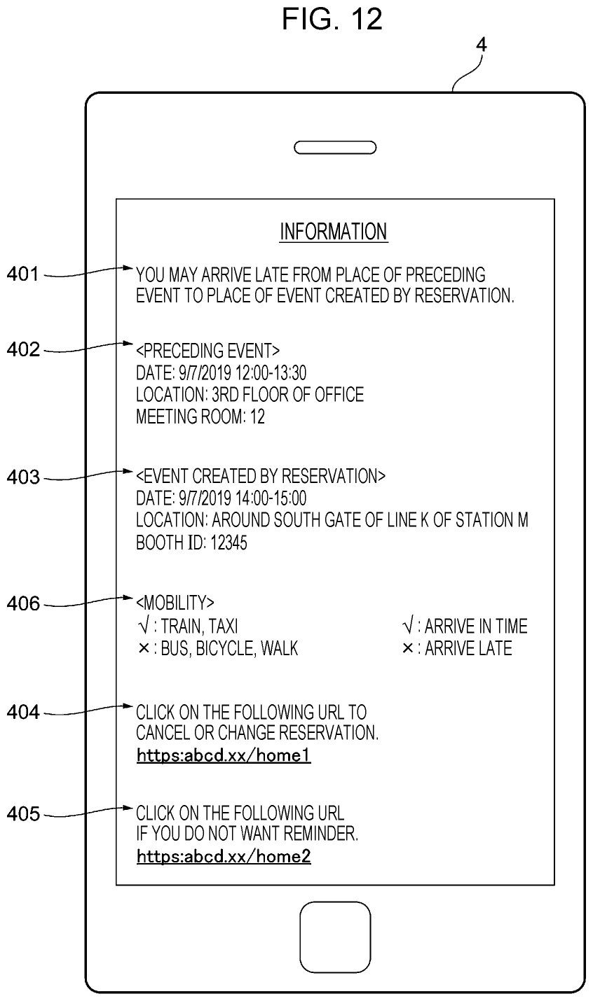

FIG. 12 illustrates another example of the notification screen to be displayed on the user terminal 4 (see FIG. 1). In the example illustrated in FIG. 12, the user is notified if the user may arrive late in some routes from the place of the preceding event to the place of the event created by the reservation subjected to determination.

FIG. 12 shows reference symbols corresponding to those in FIG. 10.

The screen illustrated in FIG. 12 includes a field 406 for displaying information on whether the user may arrive in time depending on movement methods. In this feature, the screen illustrated in FIG. 12 differs from the screen illustrated in FIG. 10. In the case of FIG. 12, the user may arrive in time by train and by taxi but may arrive late by bus, by bicycle, and on foot. Although illustration is omitted from FIG. 12, buttons for displaying details of the routes for calculation may be prepared for the respective movement methods.

Description returns to the processing in FIG. 9.

The movement management server 7 determines whether the reminder is disabled (Step 9). The reminder is disabled by clicking on the link information 405 (see FIG. 10, FIG. 11, and FIG. 12).

If the reminder is disabled, the movement management server 7 obtains a result showing “YES” in Step 9. In this case, the movement management server 7 terminates the processing without transmitting a notification.

If the result is “NO” in Step 9, the movement management server 7 determines whether a predetermined condition is satisfied (Step 10).

While the result is “NO” in Step 10, the movement management server 7 repeats the determination.

If the result is “YES” in Step 10, the movement management server 7 returns to Step 1. In this exemplary embodiment, the movement management server 7 returns to Step 1 because the event created by the reservation or the event in the schedule may be modified. That is, determination is made on the reminder by using information obtained at the time of determination.

### Other Exemplary Embodiments

The exemplary embodiment is intended for use in business but may be used in management of events in a daily life. For example, the exemplary embodiment may be used in management of events in a schedule and events created by reservations whose start time and end time are determined in advance, as typified by lessons and shopping in spaces other than home.

In the exemplary embodiment, determination is made whether the user may arrive in time between an event created by a reservation managed by the space reservation management server 5 and another event in a schedule. Determination is made whether the user may arrive in time between events in a schedule managed by the schedule management server 6.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A reservation management system, comprising:
a processor programmed to:
acquire information used to determine whether a user will arrive in time for a first event, which is a reservation for the user, through movement between a location of the first event and a location related to a second event of the user, which precedes the first event, or information used to determine whether the user will arrive in time for a third event, which succeeds the first event, through movement between the location of the first event and a location related to the third event,
make a determination whether the user will arrive in time for the first event or the third event, and
in response to a result of the determination being that the user will arrive late to the first event or the third event, provide a notification that prompts the user to take an action on the first event or the third event.

2. The reservation management system according to claim 1, wherein the processor is programmed to acquire information on the location and a time frame related to the second event or information on the location and a time frame related to the third event based on a timetable of the user.

3. The reservation management system according to claim 2, wherein the processor is programmed to, if a plurality of persons are involved in the second event, determine whether the user will arrive in time for the first event based on a period shorter than a period of idle time defined from an ending of the second event to a beginning of the first event.

4. The reservation management system according to claim 2, wherein the processor is programmed to acquire the information used to determine whether the user will arrive in time for the first event or the third event if a new event is added in the timetable prior to or subsequently to the first event.

5. The reservation management system according to claim 1, wherein the processor is programmed to provide the notification for each expected movement method of the user between the location related to the second event and the location of the first event or between the location of the first event and the location related to the third event.

6. The reservation management system according to claim 5, wherein the processor is programmed to retransmit the notification based on a predetermined rule until the user disables a reminder of the notification.

7. The reservation management system according to claim 6, wherein the processor is programmed to retransmit the notification based on updated information obtained when the notification is retransmitted.

8. The reservation management system according to claim 1,
wherein the processor is programmed to acquire the information used to determine whether the user will arrive in time for the first event based on a relationship between a current location of the user and the location related to the second event, and
wherein the processor is programmed to acquire the information used to determine whether the user will arrive in time for the third event based on a relationship between a current location of the user and the location related to the third event.

9. The reservation management system according to claim 1, wherein the processor is programmed to provide the notification with an option to cancel or change the first event as the action on the first event.

10. A non-transitory computer readable medium storing a program causing a computer to execute a process comprising:
acquiring information used to determine whether a user will arrive in time for a first event, which is a reservation for the user, through movement between a location of the first event and a location related to a second event of the user, which precedes the first event, or information used to determine whether the user will arrive in time for a third event, which succeeds the first event, through movement between the location of the first event and a location related to the third event;
making a determination whether the user will arrive in time for the first event or the third event; and
in response to a result of the determination being that the user will arrive late to the first event or the third event, providing a notification that prompts the user to take an action on the first event or the third event.

11. A reservation management system, comprising:
acquisition means for acquiring information used to determine whether a user will arrive in time for a first event, which is a reservation for the user, through movement between a location of the first event and a location related to a second event of the user, which precedes the first event, or information used to determine whether the user will arrive in time for a third event, which succeeds the first event, through movement between the location of the first event and a location related to the third event; determination means for making a determination whether the user will arrive in time for the first event or the third event; and
notification means for, in response to a result of the determination being that the user will arrive late to the first event or the third event, providing a notification that prompts the user to take an action on the first event or the third event.
